(19) United States
(12) Patent Application Publication
(10) Pub. No.: US 2013/0342408 A1
(43) Pub. Date: Dec. 26, 2013

(54) ELECTRONIC DEVICE

(71) Applicant: ACER INCORPORATED, New Taipei City (TW)

(72) Inventors: Chih-Hua Chang, New Taipei City (TW); Chung-Cheng Su, New Taipei City (TW)

(73) Assignee: ACER INCORPORATED, New Taipei City (TW)

(21) Appl. No.: 13/705,167

(22) Filed: Dec. 5, 2012

(30) Foreign Application Priority Data
Jun. 21, 2012 (TW) 101122237

(51) Int. Cl. H01Q 1/22

(52) U.S. Cl. CPC H01Q 1/22
USPC 343/720

(57) ABSTRACT

An electronic device including a metal casing, a first slot and a speaker is provided. The metal casing is electrically connected to a system ground plane. The first slot passes through the metal casing. The metal casing forms a slot antenna by using the first slot so as to receive or transmit a first radiofrequency signal. The speaker is disposed inside the metal casing, and corresponds to the first slot.

### CROSS-REFERENCE TO RELATED APPLICATION

This application claims the priority benefit of Taiwan application serial no. 101122237, filed on Jun. 21, 2012. The entirety of the above-mentioned patent application is hereby incorporated by reference herein and made a part of this specification.

### BACKGROUND OF THE INVENTION

1. Field of the Invention

The present invention is related to an electronic device and more particularly, to an electronic device forming a slot antenna by at least one slot on a metal casing.

2. Description of Related Art

With rapid development of wireless communication technique, various types of electronic devices, such as smart phones, tablet PCs and notebooks, are continuously upgraded and launched, and requirements on functions and appearance of the electronic devices also become more and more diversified. As for the requirements on uniqueness and quality of products, most of the current electronic devices adopt a full-metal casing or a back cover most made of metal material for presenting the product characteristics.

However, the appearance design with metallic sense brings the electronic device with a sense of fashion, but also brings a bigger challenge to antenna design of the electronic devices. Generally, if the antenna is covered by metal or surrounded by a large area of metal, the radiation of the antenna would be influenced such that the communication quality of the electronic device would be also influenced. How to design the appearance of the electronic device and keep the communication quality has become a great challenge to the design of the electronic devices.

### SUMMARY OF THE INVENTION

The present invention is directed to an electronic device forming a slot antenna by at least one slot on a metal casing and improving appearance design of the electronic device by the metal casing.

The present invention is directed to an electronic device including a metal casing, a first slot and a speaker. The metal casing is electrically connected to a system ground plane. The first slot passes through the metal casing, and the metal casing forms a slot antenna by using the first slot so as to receive and transmit a first radio frequency signal. The speaker is disposed inside the metal casing and corresponds to the first slot.

In an embodiment of the present invention, the electronic device further includes a first coaxial wire. The first coaxial wire includes an outer conductor and an inner conductor. Besides, the outer conductor of the first coaxial wire is electrically connected to a first connection point on the metal casing. The inner conductor of the first coaxial wire is electrically connected to a second connection point on the metal casing. The first slot is located between the first connection point and the second connection point so that the first coaxial wire crosses the first slot.

In an embodiment of the present invention, the electronic device further includes a first mesh structure, wherein the first mesh structure is disposed inside the first slot. In addition, a material of the first mesh structure is a non-conductive material.

In an embodiment of the present invention, the first slot is an open slot and a length of the first slot is a quarter of a wavelength of the first radio frequency signal.

In an embodiment of the present invention, the electronic device further includes a second slot, wherein the second slot passes through the metal casing, and the metal casing further forms the slot antenna by using the second slot so as to receive or transmit a second radio frequency signal.

To sum up, in the present invention, at least one slot on the metal casing is used for forming the slot antenna. Thus, the metal casing of the present invention is not only used for improving the appearance design of the electronic device, but also used as the slot antenna so as to assure communication quality of the electronic device. Moreover, the slots on the metal casing are further are further used as sound-output ports of the speaker so as to facilitate miniaturization development of the electronic device.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the present invention.

FIG. 1 is a three-dimensional perspective diagram illustrating an electronic device according to an embodiment of the present invention.

FIG. 2A and FIG. 2B are partial schematic diagrams respectively illustrating an electronic device according to an embodiment of the present invention.

FIG. 3A and FIG. 3B are partial schematic diagrams respectively illustrating an electronic device according to another embodiment of the present invention.

FIG. 4A, FIG. 4B and FIG. 4C are partial schematic diagrams respectively illustrating an electronic device according to still another embodiment of the present invention.

### DESCRIPTION OF EMBODIMENTS

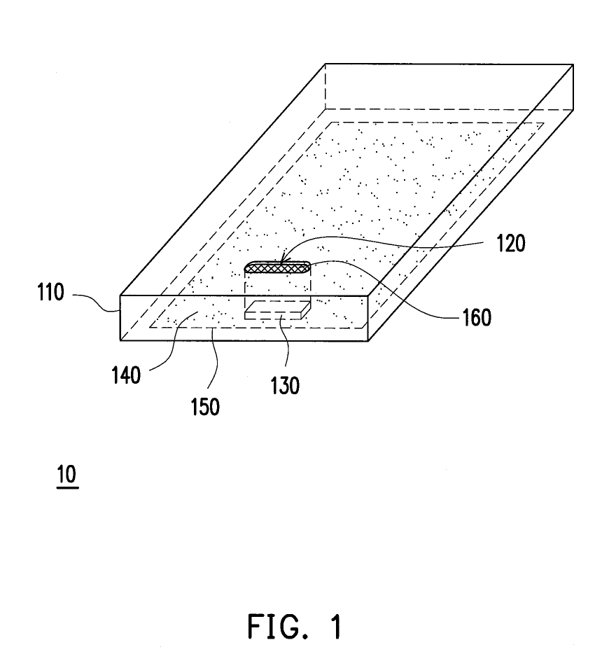

FIG. 1 is a three-dimensional perspective diagram illustrating an electronic device according to an embodiment of the present invention. An electronic device 10 includes a metal casing 110, a first slot 120, a speaker 130, a system ground plane 140, a substrate 150 and a mesh structure 160. The metal casing 110 is electrically connected to the system ground plane 140. The metal casing 110 may be electrically connected to system ground plane 140 directly or through a conductive element, such as an elastic piece, a conductive gasket or any other type of conductive element. The first slot 120 passes through the metal casing 110, and the metal casing 110 forms a slot antenna by the first slot 120 so as to receive or transmit a first radio frequency signal.

The speaker 130, the system ground plane 140 and the substrate 150 are all disposed inside the metal casing 110, and the system ground plane 140 and the speaker 130 are disposed on the substrate 150. Additionally, in such configuration, the speaker 130 corresponds to the first slot 120. Thus, sound sent by the speaker 130 can be transmitted to the external of the metal casing 110 through the first slot 120. In other words, the electronic device 10 may not only use the first slot 120 for the metal casing 110 to form the slot antenna, but also use the first slot 120 as a sound-output port of the speaker 130.

In the present embodiment, the electronic device 10 further includes a mesh structure 160. The mesh structure 160 may be disposed either inside the first slot 120 or covers the first slot 120 along inner wall of the metal casing 110. Thus, the mesh structure 160 can not only beautify the metal casing 110 but also prevent foreign bodies, such as dust, falling into the inside of the electronic device 10. In addition, a material of the mesh structure 160 is a non-conductive material to avoid influence on receiving and transmitting functions of the slot antenna.

It should be mentioned that the slot antenna maybe classified as an open slot antenna and a closed slot antenna based on its slot structure. Thus, in order to enable persons of ordinary skill in the art to understand the present invention, implementation aspects of forming the open slot antenna or the closed slot antenna by the first slot will be described in detail with reference to the drawings.

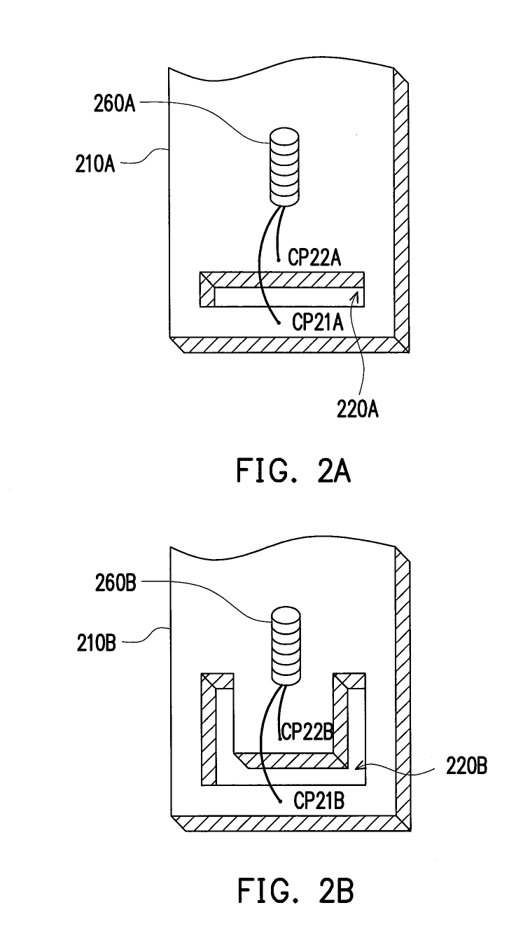

FIG. 2A and FIG. 2B are partial schematic diagrams respectively illustrating an electronic device according to an embodiment of the present invention. Here, for descriptive convenience, FIG. 2A and FIG. 2B merely illustrate a portion of a metal casing of the electronic device for describing the configuration structure of a first slot. Referring to FIG. 2A, a first slot 220A passes through a metal casing 210A, and the first slot 220A may be, for example, a line-shaped closed slot. Additionally, in the embodiment illustrated in FIG. 2A, the electronic device further includes a coaxial wire 260A, wherein the coaxial wire 260A includes an inner conductor and an outer conductor. Besides, the outer conductor of the coaxial wire 260A is electrically connected to a connection point CP21A on the metal casing 210A, and the inner conductor of the coaxial wire 260A is electrically connected to a connection point CP22A on the metal casing 210A.

It should be mentioned that in the configuration, the first slot 220A is located between the connection point CP21A and the connection point CP22A so that the coaxial wire 260A crosses the first slot 220A. Thus, the metal casing 210A may use the first slot 220A to form a closed slot antenna, and a signal received by the closed slot antenna is transmitted through the coaxial wire 260A to an internal circuit of the electronic device, such as a transceiver (not shown). Furthermore, in the actual application, positions of the connection points CP21A and CP22A and size of the first slot 220A may be adjusted so as to adjust resonant frequency and impedance match of the closed slot antenna. For example, a length of the first slot 220A is associated with a first radio frequency signal received or transmitted by closed slot antenna. Thus, in the embodiment illustrated in FIG. 2A, depending on characteristics of the closed slot antenna, the length of the first slot 220A is a half of a wavelength of the first radio frequency signal. In other words, when the first radio frequency signal has a frequency of 2.4 G Hz, the length of the first slot 220A is approximately 56 mm.

On the other hand, though in the embodiment illustrated in FIG. 2, a shape of the first slot 220A is exemplarily illustrated, the present invention is not limited thereto. The persons with the ordinary skills of this art may change the shape of the first slot 220A as in an L shape, a U shape or any other irregular geometric shape based on the design requirement. For example, as shown in FIG. 2B, a first slot 220B passes through a metal casing 210B, and is a U-shaped closed slot. In addition, an electronic device depicted in FIG. 2B further includes a coaxial wire 260B, and an outer conductor and an inner conductor of the coaxial wire 260B are electrically connected to two connection points CP21B and CP22B on the metal casing 210B, respectively. The detailed description in connection with the first slot 220B and the coaxial wire 260B of the embodiment illustrated in FIG. 2B is contained in the description of the embodiment illustrated in FIG. 2A, and thus, will not be repeated hereinafter.

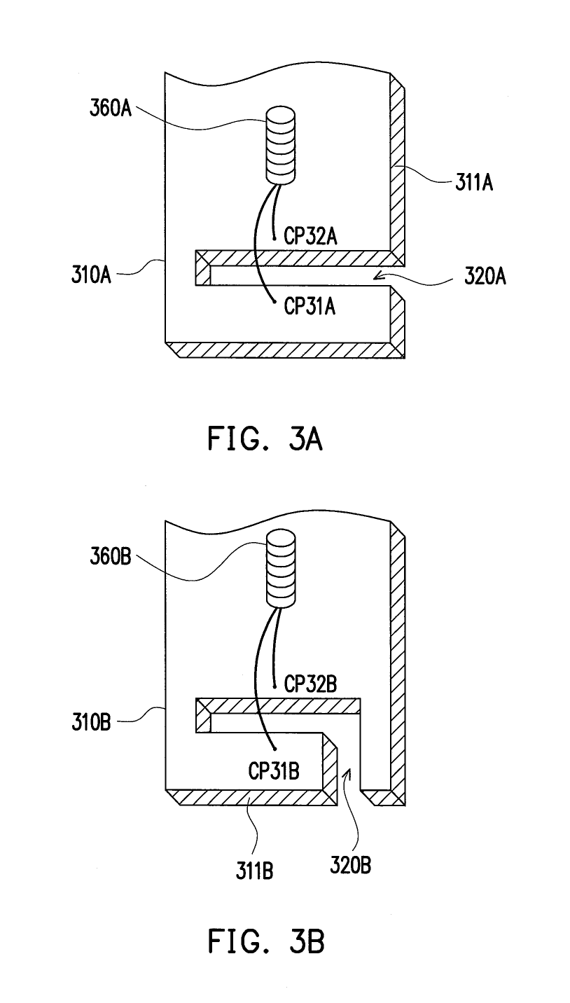

FIG. 3A and FIG. 3B are partial schematic diagrams respectively illustrating an electronic device according to another embodiment of the present invention. For descriptive convenience, FIG. 3A and FIG. 3B merely illustrate a portion of a metal casing of the electronic device for describing the configuration structure of a first slot. Referring to FIG. 3A, a first slot 320A passes through the metal casing 310A, and the first slot 320A may be, for example, a line-shaped open slot. Thus, in the actual configuration, the first slot 320A has an opening located at one side 311A of the metal casing 310A. In other words, the first slot 320A passes through the metal casing 310A staring from the side 311A of the metal casing 310A and extends toward another side of the metal casing 310A.

Additionally, in the embodiment illustrated in FIG. 3A, the electronic device further includes a coaxial wire 360A, wherein an inner conductor and an outer conductor of the coaxial wire 360A are electrically connected to connection points CP31A and CP32A on the metal casing 310A, respectively. Besides, the first slot 320A is located between the two connection points CP31A and CP32A so that the coaxial wire 360A crosses the first slot 320A. Thus, the metal casing 310A forms an open slot antenna by the first slot 320A, and a signal received by the open slot antenna is transmitted to an internal circuit of the electronic device through the coaxial wire 360A. Moreover, as for characteristics of the open slot antenna, if the open slot antenna is configured for receiving or transmitting the first radio frequency signal, then a length of the first slot 320A is a quarter of a wavelength of the first radio frequency signal. In other words, comparing with the embodiments illustrated in FIG. 2A and FIG. 2B, the open slot antenna according to the embodiment illustrated in FIG. 3A facilitates decrement of the size of the first slot.

In addition, though in the embodiment illustrated in 3A, a shape of the first slot 320A is exemplarily illustrated, the present invention is not limited thereto. Herein, the persons with ordinary knowledge of the art may change the shape of the first slot 320A as in an inverted-L shape or any other irregular geometric shape based on the design requirement. For example, as shown in FIG. 3B, a first slot 320B passes through a metal casing 310B starting from a side 311B of the metal casing 310B and extends toward another side of the metal casing 310B so as to form an inverted L-shaped open slot. In addition, the electronic device depicted in FIG. 3B further includes a coaxial wire 360B, and an outer conductor and an inner conductor of the coaxial wire 360B are electrically connected to two connection points CP31B and CP32B of the metal casing 310B, respectively. The detailed description in connection with the first slot 320B and the coaxial wire 360B of the embodiment illustrated in FIG. 3B is contained in the description of the embodiment illustrated in FIG. 3A, and thus, will not be repeated hereinafter.

It should be noted that each of the electronic devices exemplarily illustrated in FIG. 1, FIG. 2A, FIG. 2B, FIG. 3A and FIG. 3B forms the slot antenna by a single slot so as to receive and transmit the frequency radio signal in a single frequency band. However, in other embodiments, the slot antenna may be formed by more than two slots so as to receive and transmit the frequency radio signal in multiple frequency bands. In order to enable persons of ordinary skill in the art to understand the present invention, implementation aspects of the slot antenna capable of being operated in multiple frequency bands in the electronic device will be described in detail with reference to the drawings.

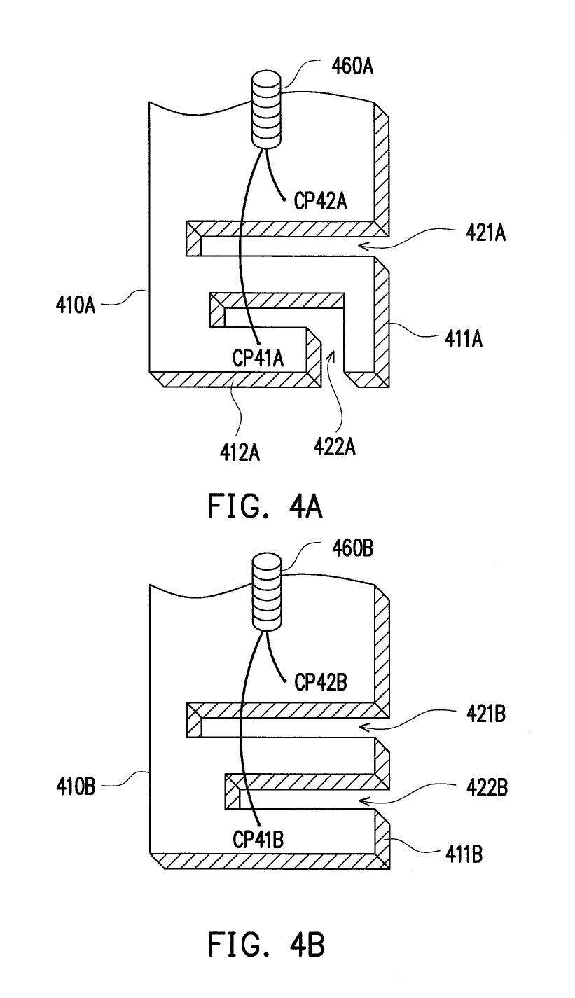

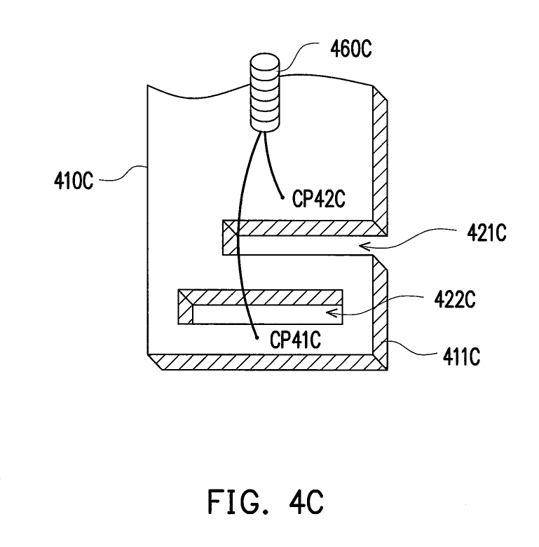

FIG. 4A, FIG. 4B and FIG. 4C are partial schematic diagrams respectively illustrating an electronic device according to still another embodiment of the present invention. Herein, FIG. 4A through FIG. 4C merely illustrate a portion of a metal casing of the electronic device for the description of the slot antenna capable of being operated in multiple frequency bands. Referring to FIG. 4A, a metal casing 410A includes a first slot 421A and a second slot 422A. Both the first slot 421A and the second slot 422A are open slots, but have different lengths and shapes. Here, the first slot 421A is a line-shaped open slot and has an opening located at one side 411A of the metal casing 410A. The second slot 422A is an inverted L-shaped open slot and has an opening located at one side 412A of the metal casing 410A.

In addition, in the embodiment illustrated in FIG. 4A, the electronic device further includes a coaxial wire 460A, wherein an inner conductor of the coaxial wire 460A is electrically connected to a connection point CP41A on the metal casing 410A. An outer conductor of the coaxial wire 460A is electrically connected to a connection point CP42A of the metal casing 410A. Besides, the first slot 421A and the second slot 422A are aligned with each other between the connection points CP41A and connection point CP42A so that the coaxial wire 460A crosses the first slot 421A and the second slot 422A.

In operation, the metal casing 410A forms the slot antenna operated in dual frequency bands by the first slot 421A and the second slot 422A, wherein the length of the first slot 421A is larger than the length of the second slot 422A. Therefore, the first slot 421A is excited in a low frequency so that the metal casing 410A may receive or transmit a first radio frequency signal in a first frequency band (e.g. 2.4 G Hz). In the opposite, the second slot 422A is excited in a high frequency so that the metal casing 410A may receive or transmit a second radio frequency signal in a second frequency band (e.g. 5 G Hz). Besides, the signal received by the metal casing 410A is transmitted through the coaxial wire 460A to an internal circuit of the electronic device, such as a transceiver (not shown).

It should be noted that in the embodiment illustrated in FIG. 4A, the openings of the two slots 421A and 422A are respectively located at the two adjacent sides 411A and 412A of the metal casing 410A. However, in other embodiments, the openings of the two slots 421A and 422A may also be located at the same side of the metal casing 410A.

For example, as shown in FIG. 4B, a metal casing 410B includes a first slot 421B and a second slot 422B. Both the first slot 421B and the second slot 422B are open slots, and openings of the two slots 421B and 422B are located at the same side 411B of the metal casing 410B. In addition, the electronic device exemplarily illustrated in FIG. 4B further includes a coaxial wire 460B. An inner conductor and an outer conductor of the coaxial wire 460B are electrically connected to two connection points CP41B and CP42B on the metal casing 410B, respectively so that a signal received by the metal casing 410B may be transmitted through the coaxial wire 460B to the internal circuit of the electronic device. The detailed description in connection with the first slot 421B, the second slot 422B and the coaxial wire 460B of the embodiment illustrated in FIG. 4B is contained in the description of the embodiment illustrated in FIG. 4A, and thus, will not be repeated hereinafter.

Moreover, in both the embodiments illustrated in FIG. 4A and FIG. 4B, the slot antenna capable of being operated in the dual frequency bands is formed by two open slots. However, in other embodiments, the slot antenna capable of being operated in the dual frequency bands may be otherwise formed by two closed slots or by any combination of open slots and closed slots.

For instance, as shown in FIG. 4C, a metal casing 410C includes a first slot 421C and a second slot 422C. The first slot 421C is a line-shaped open slot, and the second slot 422C is a line-shaped closed slot. Besides, lengths of the two slots 421C and 422C are different so that the metal casing 410C excites frequency signals operated in different frequency bands by the two slots 421C and 422C. In addition, the electronic device exemplarily illustrated in FIG. 4C further includes a coaxial wire 460C. An inner conductor and an outer conductor coaxial wire 460C are electrically connected to two connection points CP41C and CP42C on the metal casing 410C, respectively so that so that a signal received by the metal casing 410C may be transmitted through the coaxial wire 460C to the internal circuit of the electronic device. The detailed description in connection with the first slot 421C, the second slot 422C and the coaxial wire 460C of the embodiment illustrated in FIG. 4C is contained in the description of the embodiments illustrated in FIG. 4A and FIG. 4B, and thus, will not be repeated hereinafter.

It should be mentioned that for beautifying the metal casing and preventing foreign bodies falling in, the mesh structure illustrated in the embodiment of FIG. 1 may be further configured in the first slots 421A˜421C and second slots 422A˜422C exemplarily illustrated in the embodiments of FIG. 4A, FIG. 4B and FIG. 4C. Moreover, in the embodiments of FIG. 4A, FIG. 4B and FIG. 4C, all the signals operated in two different frequency bands are transmitted through a single coaxial wire. However, in other embodiments, two coaxial wires may also be used for respectively connecting to the two slots so as to transmit signals operated in different frequency bands through the two coaxial wires respectively.

Based on the above, in the present invention, at least one slot is used for passing through the metal casing so that the metal casing is equivalent to a slot antenna. Thus, the metal casing of the present invention is used not only for improving the appearance design of the electronic device, but also for preventing communication quality of the electronic device to be influenced by the metal casing. In addition, in the present invention, the speaker further corresponds to the slots on the metal casing, and thus, the slots can be used as sound-output ports of the speaker so as to facilitate miniaturization development of the electronic device.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An electronic device, comprising:
a metal casing, electrically connected to a system ground plane;
a first slot, passing through the metal casing, wherein the metal casing forms a slot antenna by using the first slot so as to receive or transmit a first radiofrequency signal; and
a speaker, disposed inside the metal casing and corresponding to the first slot.

2. The electronic device as recited in claim 1, further comprising:
a substrate, disposed inside the metal casing, wherein the system ground plane and the speaker are disposed on the substrate.

3. The electronic device as recited in claim 1, further comprising:
a first coaxial wire, comprising an outer conductor and an inner conductor, wherein the outer conductor of the first coaxial wire is electrically connected to a first connection point on the metal casing, the inner conductor of the first coaxial wire is electrically connected to a second connection point on the metal casing, and the first slot is located between the first connection point and the second connection point so that the first coaxial wire crosses the first slot.

4. The electronic device as recited in claim 1, further comprising:
a first mesh structure, disposed inside the first slot, wherein a material of the first mesh structure is a non-conductive material.

5. The electronic device as recited in claim 1, further comprising:
a first mesh structure, covering the first slot along inner wall of the metal casing, wherein a material of the first mesh structure is a non-conductive material.

6. The electronic device as recited in claim 1, wherein the first slot is an open slot, and a length of the first slot is a quarter of a wavelength of the first radio frequency signal.

7. The electronic device as recited in claim 1, wherein the first slot is a closed slot, and a length of the first slot is a half of the wavelength of the first radio frequency signal.

8. The electronic device as recited in claim 1, further comprising:
a second slot, passing through the metal casing, wherein the metal casing further forms the slot antenna by using the second slot so as to receive or transmit a second radio frequency signal.

9. The electronic device as recited in claim 8, further comprising:
a second coaxial wire, comprising an outer conductor and an inner conductor, wherein the outer conductor of the second coaxial wire is electrically connected to a third connection point on the metal casing, the inner conductor of the second coaxial wire is electrically connected to a fourth connection point on the metal casing, and the first slot and the second slot are aligned adjacently to each other between the third connection point and the fourth connection point so that the second coaxial wire crosses the first slot and the second slot.

10. The electronic device as recited in claim 8, further comprising:
a second mesh structure, disposed inside the second slot, wherein a material of the second mesh structure is a non-conductive material.

11. The electronic device as recited in claim 8, further comprising:
a second mesh structure, covering the second slot along inner wall of the metal casing, wherein a material of the second mesh structure is a non-conductive material.

12. The electronic device as recited in claim 8, wherein both the first slot and the second slot are open slots, an opening of the first slot is located at a first side of the metal casing, an opening of the second slot is located at a second side of the metal casing, and the first side and the second side are adjacent to each other.

13. The electronic device as recited in claim 8, wherein the first slot and the second slot are both closed slots.

14. The electronic device as recited in claim 8, wherein the first slot is an open slot, and the second slot is a closed slot, respectively.
